(19) United States
(12) Patent Application Publication
(10) Pub. No.: US 2023/0219829 A1
(43) Pub. Date: Jul. 13, 2023

(54) SYSTEM AND METHOD FOR SOLAR-POWERED DESALINATION AND WATER PURIFICATION

(71) Applicant: Matregenix, Inc., Irvine, CA (US)

(72) Inventors: Sherif Soliman, Irvine, CA (US); Feng Guo, Irvine, CA (US)

(73) Assignee: Matregenix, Inc., Irvine, CA (US)

(21) Appl. No.: 17/999,918

(22) PCT Filed: May 24, 2021
(86) PCT No.: PCT/US2021/033949

§ 371 Date: Nov. 25, 2022

Related U.S. Application Data
(60) Provisional application No. 63/029,502, filed on May 24, 2020.

(51) Int. Cl. C02F 1/14; B01J 21/18; B01D 1/00; B01J 35/00; B01J 35/06; B01J 35/10; B01J 37/02; B01D 5/00; C02F 1/72; C02F 1/32

(52) U.S. Cl. CPC C02F 1/14; B01J 21/18; B01D 1/0035; B01J 35/004; B01J 35/065; B01J 35/1076; B01J 37/0201; B01D 5/006; C02F 1/725; C02F 1/32; C02F 2305/08; C02F 2305/10; C02F 2305/04; C02F 2201/009; C02F 2103/08

(57) ABSTRACT

A novel solar-powered desalination and water purification system is disclosed herein. The system includes a nanofiber-impregnated graphene aerogel, an untreated water source, a water collection surface, and a purified water storage container. A novel photocatalytic nanofiber-impregnated graphene aerogel for desalination and photodegradation of contaminants for use in the disclosed system is also disclosed herein. The nanofiber-impregnated graphene aerogel exhibits excellent hydrophilicity, thermal insulation, and photodegradation capability, and allows for efficient solar-powered evaporation of water. The introduction of photocatalytic nanofibers into the graphene aerogel allows effective interfacial evaporation and in situ photodegradation of contaminants. The rate of water evaporation is preferably greater than 1.3 gal/ft² per day, and the contaminant removal is preferably greater than 90%. A method of desalinating and purifying water using the disclosed system is also disclosed herein.

### CROSS-REFERENCE TO RELATED APPLICATIONS

This application claims the benefit of, and priority to, U.S. Provisional Patent Application Ser. No. 63/029,502, filed on May 24, 2020, the disclosure of which is hereby incorporated in its entirety herein by reference.

### BACKGROUND

### Field of the Invention

The present disclosure relates to systems and methods for solar-powered desalination and water purification, and to novel materials for use in solar-powered desalination and water purification applications.

### Description of the Related Art

The need for clean water for drinking and other uses is increasingly an issue as the global population increases. It has been estimated that 2.4 billion people worldwide lack access to clean fresh water. See, e.g., World Wildlife Fund, “Water Scarcity,” available at www.worldwildlife.org/threats/water-scarcity. Many areas that lack fresh water suitable for use as drinking water have ready access to salt water, gray water, or other contaminated water sources. However, many such areas lack the infrastructure or financial resources to refine water obtained from such sources to a drinkable quality. Frequently, such areas have abundant sunlight. This unique combination has prompted the development of many solar-powered desalination systems to produce drinkable water.

Contamination of water sources is another problem that prevents access to clean fresh water. For example, the Institute for Health Metrics and Evaluation (IHME) estimated that lead exposure accounted for 1.06 million deaths and a loss of 24.4 million disability-adjusted life years in 2017. See World Health Organization, “Lead Poisoning and Health,” available at www.who.int/en/news-room/fact-sheets/detail/lead-poisoning-and-health. A significant source of lead poisoning is lead-contaminated water sources. Id. A variety of approaches have been explored to remove toxic substances from water or utilize alternative water sources, including precipitation, see, e.g., Gharabaghi, M., et al. “Selective Sulphide Precipitation of Heavy Metals from Acidic Polymetallic Aqueous Solution by Thioacetamide,” Ind. Eng. Chem. Res. 2012, 51, 954-63; Lin, Y.-F., et al. “Application of Bifunctional Magnetic Adsorbent to Adsorb Metal Cations and Anionic Dyes in Aqueous Solution,” J. Hazard. Mater. 2011, 185, 1124-30, flocculation, see, e.g., Szygula, A., et al. “The Removal of Sulphonated Azo-Dyes by Coagulation with Chitosan. Colloids Surf A Physicochem. Eng. Asp. 2008, 330, 219-26; Fu, F., et al. “Removal of Heavy Metal Ions from Wastewaters: A Review,” J. Environ. Manage. 2011, 92, 407-18, electrochemical technologies, see, e.g., Černá, M. “Use of Solvent Extraction for the Removal of Heavy Metals from Liquid Wastes,” Environ. Monit. Assess. 1995, 34, 151-62; Hasan, S., et al. “Molecular and Ionic-Scale Chemical Mechanisms behind the Role of Nitrocyl Group in the Electrochemical Removal of Heavy Metals from Sludge,” Sci. Rep. 2016, 6, 31828, ion exchange, see, e.g., Vilensky, M. Y., et al. “In Situ Remediation of Groundwater Contaminated by Heavy- and Transition-Metal Ions by Selective Ion-Exchange Methods, Environ. Sci. Technol. 2002, 36, 1851-55; Shaidan, N. H., et al. “Removal of Ni(II) Ions from Aqueous Solutions Using Fixed-Bed Ion Exchange Column Technique,” J. Taiwan Inst. Chem. Eng. 2012, 43, 40-45; Chan, B., et al. “Reverse Osmosis Removal of Arsenic Residues from Bioleaching of Refractory Gold Concentrates,” Miner. Eng. 2008, 21, 272-78, and filtration, see, e.g., Hua, M., et al. “Heavy Metal Removal from Water/Wastewater by Nanosized Metal Oxides: A Review,” J. Hazard. Mater. 2012, 211, 317-31; Shannon, M. A., et al. “Science and Technology for Water Purification in the Coming Decades,” Nature, 2008, 452, 301-10; Herrmann, S., et al. “Removal of Multiple Contaminants from Water by Polyoxometalate Supported Ionic Liquid Phases (POM-SILPs),” Angew. Chem. Int. Ed. Engl. 2017, 56, 1667-70. These treatments, however, involve complicated processes and expensive instruments, making their deployment and widespread use challenging, especially in impoverished regions. See, e.g., Bhattacharya, K., et al. “Mesoporous Magnetic Secondary Nanostructures as Versatile Adsorbent for Efficient Scavenging of Heavy Metals,” Sci. Rep. 2015, 5, 17072; Li, B., et al. “Environmentally Friendly Chitosan/PEI-Grafted Magnetic Gelatin for the Highly Effective Removal of Heavy Metals from Drinking Water,” Sci. Rep. 2017, 7, 43082; Wang, Y., et al. “Rapid Removal of Pb(II) from Aqueous Solution Using Branched Polyethylenimine Enhanced Magnetic Carboxymethyl Chitosan Optimized with Response Surface Methodology,” Sci. Rep. 2017, 7, 10264; Alagappan, P. N., et al. “Easily Regenerated Readily Deployable Absorbent for Heavy Metal Removal from Contaminated Water,” Sci. Rep. 2017, 7, 6682; Vojoudi, H., et al. “A New Nano-Sorbent for Fast and Efficient Removal of Heavy Metals from Aqueous Solutions Based on Modification of Magnetic Mesoporous Silica Nanospheres,” J. Magn. Magn. Mater. 2017, 441, 193-203; Esmaeilion, F. “Hybrid Renewable Energy Systems for Desalination,” Appl. Water Sci. 2020, 10, 84.

To meet the urgent demand for clean sources of fresh water, solar-powered evaporation offers significant promise as an economical and practical solution for water desalination and purification, particularly in remote and off-grid areas. See, e.g., Chel, A., et al. “Renewable Energy Technologies for Sustainable Development of Energy Efficient Building,” Alex. Eng. 1 2018, 57, 655-69; Li, C., et al. “Solar Assisted Sea Water Desalination: A Review,” Renew. Sust. Energ. Rev. 2013, 19, 136-63; Lewis, N. S. “Research Opportunities to Advance Solar Energy Utilization,” Science, 2016, 351, aad1920. Solar-powered evaporation is a sustainable and low-cost approach to water purification. Chen, C., et al. “Challenges and Opportunities for Solar Evaporation,” Joule, 2019, 3, 683-718. However, current solar-powered evaporation technology still has significant shortcomings. First, the thermal efficiency of the process is still relatively low, which is a hurdle for commercialization. See, e.g., Morciano, M., et al. “Efficient Steam Generation by Inexpensive Narrow Gap Evaporation Device for Solar Applications,” Sci. Rep. 2017, 7, 1-9. Second, certain toxic volatile organic compounds (VOCs) will inevitably be evaporated with the water targeted for evaporation and thus contaminate the water vapor, rendering the water obtained by the process unsafe for direct use. See, e.g., Meng, X., et al. “Coupling of Hierarchical Al₂O₃/TiO₂ Nanofibers into 3D Photothermal Aerogels Toward Simultaneous Water Evaporation and Purification,” Adv Fiber Mater. 2020, 2, 93-104.

The wettability of most smart separation membranes is determined by external environmental factors such as temperature, pH, and pressure. When these parameters are substantially constant, the wettability of the smart separation membrane cannot be changed and thus the membrane can only be used to separate a single type of wastewater. In addition, in some extreme environments, the membrane also will lose its separation ability, which significantly limits the type of applications in which it may be used. Superwetting interfacial nanofiber membranes with switchable wettability have enormous potential for wastewater treatment and desalination. See Li, L., et al. “Bio-Inspired Membrane with Adaptable Wettability for Smart Oil/Water Separation, J. Membr. Sci. 2019, 598, 117661. Xie, A., et al. “Dual Superlyophobic Zeolitic Imidazolate Framework-8 Modified Membrane for Controllable Oil/Water Emulsion Separation,” Sep. Purif. Technol. 2020, 236, 116273.

Thus there remains a need for a solar-powered desalination and water purification system with switchable wettability and a high evaporation rate that is capable of in situ removal of contaminates.

### SUMMARY

A novel solar-powered desalination and water purification system is disclosed herein. The system includes a nanofiber-impregnated graphene aerogel, an untreated water source, a water collection surface, and a purified water storage container. A novel photocatalytic nanofiber-impregnated graphene aerogel for desalination and photodegradation of contaminants for use in the disclosed system is also disclosed herein. The nanofiber-impregnated graphene aerogel exhibits excellent hydrophilicity, thermal insulation, and photodegradation capability, and allows for efficient solar-powered evaporation of water. The introduction of photocatalytic nanofibers into the graphene aerogel allows effective interfacial evaporation and in situ photodegradation of contaminants. The rate of water evaporation is preferably greater than 1.3 gal/ft² per day, and the contaminant removal is preferably greater than 90%. A method of desalinating and purifying water using the disclosed system is also disclosed herein.

### BRIEF DESCRIPTION OF THE DRAWINGS

FIGS. 1A-1C show an embodiment of the disclosed system.

FIG. 2 shows the embodiment shown in FIGS. 1A-1C being used to purify water.

### DETAILED DESCRIPTION

A novel solar-powered desalination and water purification system is disclosed herein. The system includes a nanofiber-impregnated graphene aerogel, an untreated water source, a water collection surface, and a purified water storage container. A novel photocatalytic nanofiber-impregnated graphene aerogel for desalination and photodegradation of contaminants for use in the disclosed system is also disclosed herein. The nanofiber-impregnated graphene aerogel exhibits excellent hydrophilicity, thermal insulation, and photodegradation capability, and allows for efficient solar-powered evaporation of water. The introduction of photocatalytic nanofibers into the graphene aerogel allows effective interfacial evaporation and in situ photodegradation of contaminants. The rate of water evaporation is preferably greater than 1.3 gal/ft² per day, and the contaminant removal is preferably greater than 90%. A method of desalinating and purifying water using the disclosed system is also disclosed herein.

Graphene aerogels are ultra-low density materials with high compressibility. See, e.g., Mecklenburg, M., et al. “Aerographite: Ultra Lightweight, Flexible Nanowall, Carbon Microtube Material with Outstanding Mechanical Performance,” Adv. Mater. 2012, 24, 3486-90; Hu, H., et al. “Ultralight and Highly Compressible Graphene Aerogels,” Adv. Mater. 2013, 25 2219-23; Zhu, C., et al. “Highly Compressible 3D Periodic Graphene Aerogel Microlattices,” Nat. Commun. 2015, 6, 1-8. Graphene aerogels are composed of a three-dimensional network of covalently bonded graphene sheets that surround large empty pores that may be filled with air. See, e.g., Zhu, C., et al., supra. The morphology of graphene aerogels may be controlled using 3D printing techniques. Id.

Electrospinning is a very useful technique that provides efficiency and uniformity of pore size. See, e.g., Ray, S. S., et al. “A Comprehensive Review: Electrospinning Technique for Fabrication and Surface Modification of Membranes for Water Treatment Application,” RSC Adv. 2016, 6(88), 85495-85514, doi: 10.1039/C6RA14952A. Electrospinning is a process that uses an electric field to generate continuous fibers on a micrometer or nanometer scale. Electrospinning enables direct control of the microstructure of a scaffold, including characteristics such as the fiber diameter, orientation, pore size, and porosity. Electrospun nanofibers have a wide range of applications. These include antibacterial food packaging, see, e.g., Lin, L., et al. “Cold Plasma Treated Thyme Essential Oil/Silk Fibroin Nanofibers against Salmonella Typhimurium in Poultry Meat,” Food Packag. Shelf Life, 2019, 21, 100337; Zhu, Y., et al. “A Novel Polyethylene Oxide/Dendrobium officinale Nanofiber: Preparation, Characterization and Application in Pork Packaging,” Food Packag. Shelf Life, 2019, 21, 100329; Surendhiran, D., et al. “Encapsulation of Phlorotannin in Alginate/PEO Blended Nanofibers to Preserve Chicken Meat from Salmonella Contaminations,” Food Packag. Shelf Life, 2019, 21, 100346, biomedical applications, see, e.g., Khan, M.Q., et al. “The Development of Nanofiber Tubes Based on Nanocomposites of Polyvinylpyrrolidone Incorporated Gold Nanoparticles as Scaffolds for Neuroscience Application in Axons,” Text. Res. 1 2019, 89, 2713-20, doi: 10.1177/0040517518801185; Ullah, S., et al. “Antibacterial Properties of In Situ and Surface Functionalized Impregnation of Silver Sulfadiazine in Polyacrylonitrile Nanofiber Mats,” Int. J. Nanomedicine, 2019, 14, 2693-2703, doi: 10.2147/IJN.S197665; Khan, M. Q., et al. “Fabrication of Antibacterial Electrospun Cellulose Acetate/Silver-Sulfadiazine Nanofibers Composites for Wound Dressings Applications,” Polym. Test. 2019, 74, 39-44, doi: 10.1016/j polymertesting.2018.12.015, and environmental applications. See, e.g., Ray, S. S., et al., supra.

The nanofibers are preferably generated using electrospinning. The nanofibers may alternatively be generated using another technique such as phase inversion, interfacial polymerization, stretching, track-etching, or another suitable technique.

In some embodiments, the nanofibers may preferably form a nanofibrous membrane prior to impregnation into the graphene aerogel.

Graphene aerogels are black. Using a black graphene aerogel leads to enhanced absorption of the solar flux and thereby leads to increased evaporation.

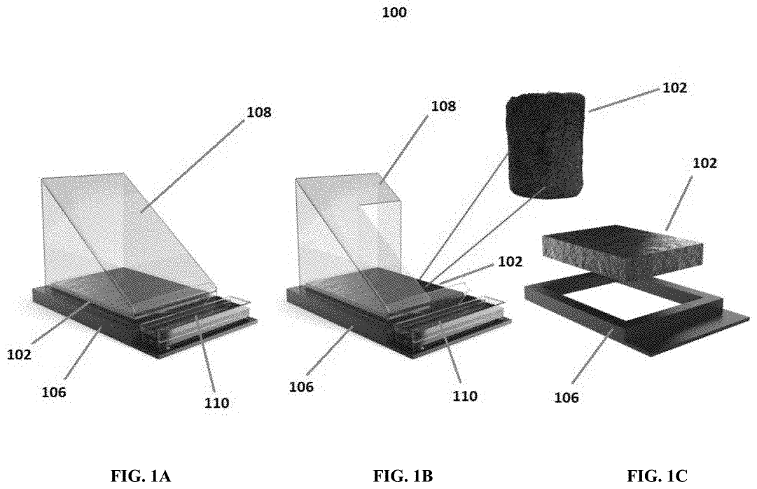

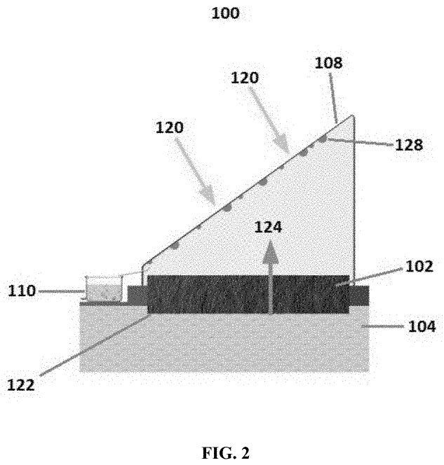

FIGS. 1A-1C and FIG. 2 show an embodiment 100 of the disclosed system. The system includes a nanofiber-impregnated graphene aerogel 102, an untreated water source 104 held in an untreated water storage container 106, a water collection surface 108, and a purified water storage container 110. The aerogel 102 is situated on the surface of an untreated water source and is covered by the water collection surface 108. FIG. 1A shows the system 100 as configured for use. FIG. 1B shows the system 100 as configured for use with a cutout of the system and an exploded view of the aerogel 102. FIG. 1C shows how the aerogel is situated in the untreated water storage container 106. FIG. 2 depicts the system in use for water purification. As shown in FIG. 2, the aerogel 102 is exposed to sunlight 120 and absorbs solar flux, causing untreated water 122 at the interface of the aerogel and the untreated water source to evaporate. Water vapor 124 then enters the pores of the aerogel 102 and subsequently exits the aerogel. Volatile contaminants in the untreated water source 104 also evaporate and enter the pores of the aerogel. The volatile contaminants contact nanofibers impregnated in the aerogel 102 and are photodegraded thereon. Upon exiting the aerogel 102, water vapor 124 reaches the water collection surface 108 and is condensed thereon to yield purified water 128. The purified water 128 is then transported to the purified water storage container 110. The water collection surface 108 may preferably positioned at an angle with respect to the aerogel 102 to facilitate transfer of purified water 128 from the water collection surface 108 to the purified water storage container 110. Purified water 128 may preferably drip from the water collection surface 108 into the purified water storage container 110 on account of gravity.

The use of nanofibers provides a large surface area, enriched pores, and unique one-dimensional structures for photodegradation of volatile organic compounds (VOCs). See, e.g., Kenry, S. M., et al. “Nanofiber Technology: Current Status and Emerging Developments,” Prog. Polym. Sci. 2017, 70, 1-17. The three-dimensional graphene aerogel significantly enhances solar flux utilization through multiple light-matter interactions and recovery of most of the diffuse reflected light. See, e.g., Mao, J., et al. “Graphene Aerogels for Efficient Energy Storage and Conversion,” Energy Environ. Sci. 2018, 11, 772-99. Impregnating nanofibers into the graphene aerogel results in improved water vapor transfer through a wicking effect. See, e.g., Liu, X., et al. “Solar Thermal Utilizations Revived by Advanced Solar Evaporation,” Curr. Opin. Chem. Eng. 2019, 25, 26-34.

The nanofibers may be fabricated using a variety of photocatalytic materials such as TiO₂, N-doped TiO₂, Ag-doped TiO₂, Al₂O₃—TiO₂, and CuO, or related soluble precursors of these materials.

The nanofibers may be generated using electrospinning. In some embodiments, the nanofibers may be fabricated using a suspension of photocatalytic nanoparticles in a solvent and a polymer dissolved in the solvent as a carrier for the photocatalytic material, termed a “precursor suspension” herein below. The polymer may be, for example, polyvinylidene fluoride (PVDF), Nylon-6, or polyvinylpyrrolidone (PVP). The solvent may, for example, be water, ethanol, acetic acid, dimethylformamide (DMF), acetone, or a mixture of two or more of the foregoing. In other embodiments, the nanofibers may be fabricated using a solution of a photocatalytic material or a soluble precursor of a photocatalytic material in an appropriate solvent, such as water, a suitable organic solvent such as dimethylformamide (DMF), dimethylacetamide (DMA), hexafluoroisopropanol (HFIP), or acetone, a combination of water and an organic solvent, or a combination of organic solvents, without using a polymer as a carrier, termed a “precursor solution” herein below.

In some embodiments, a surfactant may be added to the precursor suspension or precursor solution. Adding a surfactant to the precursor suspension or precursor solution may promote a smaller fiber diameter and thus yield a nanofibrous membrane which has a smaller pore size. In some preferred embodiments, the surfactant may be one or more surfactants selected from the group consisting of polyvinylpyrrolidone (PVP), cetrimonium bromide (CTAB), lauramidopropyl betaine (LAPB), and alpha olefin sulfonate (AOS).

The wettability of the nanofibrous membrane generated may be adjusted using SiO₂ and ZnO nanoparticles. In some embodiments, the nanoparticles are mixed into the precursor suspension. In other embodiments, a surface with switchable wettability is fabricated via a spray-coating or spin-coating process. Switchable wettability refers to the coating of a single side of the nanofibrous membrane, such that one side of the nanofibrous membrane is hydrophilic and the other side of the nanofibrous membrane is hydrophobic. Thus, by reversing the membrane, the hydrophilicity may be switched from hydrophilic to hydrophobic or vice versa.

The nanofibrous membrane may be a single layer membrane or may alternatively be an integrated multi-layer membrane. In some embodiments, the membrane may be composed of multiple integrated layers with distinguishable microstructure characteristics. A membrane that is composed of multiple integrated layers may increase the wicking effect of the nanofibers to improve the evaporation rate of water that interacts with the nanofibers.

In some embodiments, the integrated multi-layer membrane is composed of two layers with different pore sizes. In some alternate embodiments, the integrated multi-layer membrane is composed of three layers with two layers of equal pore size separated by a layer with a different pore size. The pore size may preferably be between 1 and 20 μm for the layer(s) with smaller pore size and between 20 and 200 μm for the layer(s) with larger pore size.

In embodiments with three layers having two layers of equal pore size separated by a layer with a different pore size, the layers of equal size may preferably have a larger pore size and the layer in between these two layers may preferably have a smaller pore size.

In some other alternate embodiments, the integrated multi-layer membrane is composed of three layers with three different pore sizes.

The pore size of the layers in integrated multi-layer membranes may be adjusted by adjusting the viscosity of the precursor suspension or precursor solution and the electrospinning process conditions. Electrospinning process conditions may be adjusted to further stabilize the spinning jet used in the electrospinning setup. Solutions with lower viscosity will typically generate smaller pore size layers, and solutions with higher viscosity will typically generate larger pore size layers.

In some embodiments, the mechanical integrity and binding forces between layers of the membrane may be enhanced by electrospraying short fibers prior to electrospinning the subsequent layer. In some other embodiments, the mechanical integrity and binding forces between layers of the membrane may be enhanced by electrospinning wet fibers by decreasing the screen distance to generate a “tacky surface” prior to electrospinning the subsequent layer.

In some embodiments, the nanofiber-impregnated graphene aerogel is generated according to the following procedure. A suspension, colloid, or solution of an electrospun nanofibrous material containing a photocatalytic material is evenly dispersed in water or another suitable solvent. The concentration of the nanofibrous material may preferably be between about 1 mg/mL and about 100 mg/mL. A graphene oxide colloid is separately generated using a modified Hummers' method. The concentration of the graphene oxide colloid may preferably be between about 0.1 mg/mL and about 10 mg/mL. The suspension, colloid, or solution of nanofibrous material is added into the graphene oxide colloid to obtain a reaction precursor. The reaction precursor is then uniformly mixed and hydrothermally reacted. The temperature of the hydrothermal reaction may preferably be between about 150° C. and 200° C. The resultant hydrogel may be placed in a refrigerator and then subsequently freeze-dried to generate a graphene aerogel. The graphene aerogel generated may preferably have a thickness between about 0.1 m and about 0.5 m.

Methods of generating purified water using the disclosed system are also disclosed herein. A nanofiber-impregnated graphene aerogel situated on the surface of an untreated water source and covered by an impermeable water collection surface is exposed to sunlight. The aerogel absorbs the solar flux, causing water at the interface of the aerogel and the untreated water source to evaporate. Water vapor then enters the pores of the aerogel. Volatile contaminants in the untreated water source also evaporate and enter the pores of the aerogel. The volatile contaminants contact nanofibers within the graphene aerogel and are photodegraded thereon. Upon exiting the aerogel, water vapor reaches the water collection surface and is condensed thereon to yield purified water. The purified water is then transported to a purified water container.

### Example

The following example is provided as a specific illustration. It should be understood, however, that the invention is not limited to the specific details set forth in the example. All parts and percentages in the example, as well as in the remainder of the disclosure, are by weight unless otherwise specified.

Further, any range of numbers recited above or in the paragraphs hereinafter describing or claiming various aspects of the invention, such as ranges that represent a particular set of properties, units of measure, conditions, physical states or percentages, is intended to literally incorporate expressly herein by reference or otherwise, any number falling within such range, including any subset of numbers or ranges subsumed within any range so recited. The term “about” when used as a modifier for or in conjunction with a variable, is intended to convey that the numbers and ranges disclosed herein may be flexible as understood by ordinarily skilled artisans and that practice of the disclosed invention by those skilled in the art using temperatures, concentrations, amounts, contents, carbon numbers, and properties that are outside of a literal range will achieve the desired result, namely, a system for solar-powered desalination and water purification that uses a photocatalytic nanofiber-impregnated graphene aerogel.

### Preparation of Nanofiber-Impregnated Graphene Aerogels

A precursor solution is prepared with 5 mL of a 1-100 mg/mL solution of a photocatalytic material or photocatalytic material precursor selected from the group consisting of titanium tetraisopropoxide, Al(acac)₃, AgNO₃, or CuO, 2 g of a surfactant selected from the group consisting of polyvinylpyrrolidone (PVP), lauramidopropyl betaine (LAPB), alpha olefin sulfonate (AOS), and cetrimonium bromide (CTAB), 1 mL of silicic acid tetraethyl ester (TEOS), 10 mL of ethanol, and 2 mL of acetic acid. The solution is subsequently stirred on a stirring plate for over 12 h.

Nanofibers are fabricated using an electrospinning apparatus and a calicination method. The process parameters used for electrospinning are a flow rate of 0.5 mL/h, a vertical distance from the needle to grounded aluminum foil of 10-15 cm, and an applied voltage of 15-20 kV. The electrospun nanofibers are calcined at 600° C. for 2 h in air, with a ramping rate of 1-3° C./min.

A superhydrophobic surface is fabricated via a spray-coating process. 5 g of ZnO nanoparticles (50 nm) and 5 g SiO₂ nanoparticles (15 nm) are dispersed in 200 mL absolute ethanol and an appropriate amount of waterborne polyurethane (PU) and trimethoxy(octadecyl)silane (OTMS) are added. The mixture is then magnetically stirred for at least 1 h until a uniform suspension is formed. The suspension is uniformly sprayed onto one side of the SiO₂/TiO₂ nanofibrous membrane, generating a surface coated with Si and Zn nanoparticles that exhibits superhydrophobicity.

The electrospun nanofibers are subsequently added to water at a concentration of about 1-100 mg/mL and substantially uniformly dispersed to generate a nanofiber suspension. The nanofiber suspension is added into a 0.1-10 mg/mL graphene oxide colloid to obtain a reaction precursor. The mass ratio between nanofibers and reduced graphene oxide in the reaction precursor may vary depending on the relative concentrations of the starting materials. The reaction precursor is then uniformly mixed and hydrothermally reacted at 180° C. for 8 h in an autoclave. The resultant hydrogel is frozen in a refrigerator followed by freeze-drying under −50° C. for 8-12 h in a freeze-drier to generate a nanofiber-impregnated graphene aerogel.

### Performance of Nanofiber-Impregnated Graphene Aerogels

To investigate the performance of the various nanofiber-impregnated graphene aerogels, wettability, thermal conductivity, evaporation rate, and photodegradation efficiency is analyzed using field-emission scanning electron microscopy (SEM), Raman spectroscopy, a contact angle measurement device, UV-Vis spectroscopy, and high performance liquid chromatography (HPLC). Solar flux-to-vapor conversion efficiency is calculated based on evaporation rates. The optimal composite nanofiber-impregnated graphene aerogel, which provides a high evaporation and purification performance, is determined and selected based on the results obtained.

The nanofiber-impregnated graphene aerogel is used in a solar-powered desalination and water purification system as shown in FIGS. 1A-1C and FIG. 2. The photocatalytic nanofiber-impregnated graphene aerogel results in effective interfacial evaporation for a rapid water evaporation rate of greater than 1.3 gal/ft² per day and strong water vapor generation. The contaminants within the water vapor are removed in situ by photodegradation, thereby purifying contaminated wastewater with greater than 90% contaminant removal.

The previous description of the disclosed embodiments is provided to enable any person skilled in the art to make or use the invention disclosed herein. Although the various inventive aspects are disclosed in the context of one or more illustrated embodiments, implementations, and examples, it should be understood by those skilled in the art that the invention extends beyond the specifically disclosed embodiments to other alternative embodiments and/or uses of the invention and obvious modifications and equivalents thereof. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

All references cited are hereby expressly incorporated herein by reference.

What is claimed is:

1. A solar-powered desalination and water purification system comprising:
a. a nanofiber-impregnated graphene aerogel;
b. an untreated water storage container that is configured to contain untreated water;
c. a water collection surface; and
d. a purified water storage container;
wherein the graphene aerogel is situated on the surface of untreated water that is contained within the untreated water storage container, and
wherein the graphene aerogel is covered by the water collection surface.

2. The system of claim 1, wherein the water collection surface is positioned at an angle with respect to the graphene aerogel.

3. The system of claim 1, wherein the system is used to generate purified water and wherein the purified water drips from the water collection surface into the purified water storage container on account of gravity.

4. The system of claim 1, wherein the nanofiber-impregnated graphene aerogel is photocatalytic.

5. The system of claim 1, wherein the nanofiber-impregnated graphene aerogel is impregnated with nanofibers that are generated using an electrospinning process.

6. The system of claim 4, wherein the nanofiber-impregnated graphene aerogel is impregnated with nanofibers that are generated using an electrospinning process.

7. The system of claim 5, wherein the nanofibers are fabricated using one or more photocatalytic materials selected from the group consisting of TiO₂, N-doped TiO₂, Ag-doped TiO₂, Al₂O₃—TiO₂, and CuO, and soluble precursors thereof.

8. The system of claim 6, wherein the nanofibers are fabricated using one or more photocatalytic materials selected from the group consisting of TiO₂, N-doped TiO₂, Ag-doped TiO₂, Al₂O₃—TiO₂, and CuO, and soluble precursors thereof.

9. The system of claim 5, wherein the nanofibers are fabricated using a precursor suspension, wherein the precursor suspension is a suspension of the photocatalytic material in a solvent and a polymer dissolved in the solvent as a carrier for the photocatalytic material.

10. The system of claim 6, wherein the nanofibers are fabricated using a precursor suspension, wherein the precursor suspension is a suspension of the photocatalytic material in a solvent and a polymer dissolved in the solvent as a carrier for the photocatalytic material.

11. The system of claim 5, wherein the nanofibers are fabricated using a precursor solution, wherein the precursor solution is a solution of a photocatalytic material or a soluble precursor of a photocatalytic material in a solvent.

12. The system of claim 6, wherein the nanofibers are fabricated using a precursor solution, wherein the precursor solution is a solution of a photocatalytic material or a soluble precursor of a photocatalytic material in a solvent.

13. The system of claim 9, wherein the precursor suspension further comprises a surfactant.

14. The system of claim 10, wherein the precursor suspension further comprises a surfactant.

15. The system of claim 11, wherein the precursor solution further comprises a surfactant.

16. The system of claim 12, wherein the precursor solution further comprises a surfactant.

17. The system of claim 13, wherein the surfactant is one or more surfactants selected from the group consisting of polyvinylpyrrolidone (PVP), cetrimonium bromide (CTAB), lauramidopropyl betaine (LAPB), and alpha olefin sulfonate (AOS).

18. The system of claim 14, wherein the surfactant is one or more surfactants selected from the group consisting of polyvinylpyrrolidone (PVP), cetrimonium bromide (CTAB), lauramidopropyl betaine (LAPB), and alpha olefin sulfonate (AOS).

19. The system of claim 15, wherein the surfactant is one or more surfactants selected from the group consisting of polyvinylpyrrolidone (PVP), cetrimonium bromide (CTAB), lauramidopropyl betaine (LAPB), and alpha olefin sulfonate (AOS).

20. The system of claim 16, wherein the surfactant is one or more surfactants selected from the group consisting of polyvinylpyrrolidone (PVP), cetrimonium bromide (CTAB), lauramidopropyl betaine (LAPB), and alpha olefin sulfonate (AOS).

21. The system of claim 9, wherein the nanofibers are formed into a membrane having a top surface and a bottom surface, and wherein only one of the top surface and the bottom surface is coated with nanoparticles.

22. The system of claim 10, wherein the nanofibers are formed into a membrane having a top surface and a bottom surface, and wherein only one of the top surface and the bottom surface is coated with nanoparticles.

23. The system of claim 9, wherein the nanofibers are formed into a multi-layer membrane.

24. The system of claim 10, wherein the nanofibers are formed into a multi-layer membrane.

25. The system of claim 11, wherein the nanofibers are formed into a multi-layer membrane.

26. The system of claim 12, wherein the nanofibers are formed into a multi-layer membrane.

27. The system of claim 23, wherein the membrane is composed of multiple integrated layers with distinguishable microstructure characteristics.

28. The system of claim 24, wherein the membrane is composed of multiple integrated layers with distinguishable microstructure characteristics.

29. The system of claim 25, wherein the membrane is composed of multiple integrated layers with distinguishable microstructure characteristics.

30. The system of claim 26, wherein the membrane is composed of multiple integrated layers with distinguishable microstructure characteristics.

31. The system of claim 27, wherein the membrane is composed of two layers with different pore sizes.

32. The system of claim 28, wherein the membrane is composed of two layers with different pore sizes.

33. The system of claim 29, wherein the membrane is composed of two layers with different pore sizes.

34. The system of claim 30, wherein the membrane is composed of two layers with different pore sizes.

35. The system of claim 27, wherein the membrane is composed of three layers, wherein a first layer has a first pore size, a second layer has a second pore size, and a third layer has a third pore size, wherein second layer is between the first layer and the third layer, and wherein the first pore size and the third pore size are approximately equal and the second pore size is different from the first pore size and the third pore size.

36. The system of claim 28, wherein the membrane is composed of three layers, wherein a first layer has a first pore size, a second layer has a second pore size, and a third layer has a third pore size, wherein second layer is between the first layer and the third layer, and wherein the first pore size and the third pore size are approximately equal and the second pore size is different from the first pore size and the third pore size.

37. The system of claim 29, wherein the membrane is composed of three layers, wherein a first layer has a first pore size, a second layer has a second pore size, and a third layer has a third pore size, wherein second layer is between the first layer and the third layer, and wherein the first pore size and the third pore size are approximately equal and the second pore size is different from the first pore size and the third pore size.

38. The system of claim 30, wherein the membrane is composed of three layers, wherein a first layer has a first pore size, a second layer has a second pore size, and a third layer has a third pore size, wherein second layer is between the first layer and the third layer, and wherein the first pore size and the third pore size are approximately equal and the second pore size is different from the first pore size and the third pore size.

39. The system of claim 35, wherein the first pore size is greater than the second pore size.

40. The system of claim 36, wherein the first pore size is greater than the second pore size.

41. The system of claim 37, wherein the first pore size is greater than the second pore size.

42. The system of claim 38, wherein the first pore size is greater than the second pore size.

43. The system of claim 27, wherein the membrane is composed of three layers, wherein a first layer has a first pore size, a second layer has a second pore size, and a third layer has a third pore size, wherein second layer is between the first layer and the third layer, wherein the first pore size is different from the second pore size and the third pore size, and wherein the second pore size is different from the third pore size.

44. The system of claim 28, wherein the membrane is composed of three layers, wherein a first layer has a first pore size, a second layer has a second pore size, and a third layer has a third pore size, wherein second layer is between the first layer and the third layer, wherein the first pore size is different from the second pore size and the third pore size, and wherein the second pore size is different from the third pore size.

45. The system of claim 29, wherein the membrane is composed of three layers, wherein a first layer has a first pore size, a second layer has a second pore size, and a third layer has a third pore size, wherein second layer is between the first layer and the third layer, wherein the first pore size is different from the second pore size and the third pore size, and wherein the second pore size is different from the third pore size.

46. The system of claim 30, wherein the membrane is composed of three layers, wherein a first layer has a first pore size, a second layer has a second pore size, and a third layer has a third pore size, wherein second layer is between the first layer and the third layer, wherein the first pore size is different from the second pore size and the third pore size, and wherein the second pore size is different from the third pore size.

47. The system of claim 5, wherein the electrospinning process includes electrospraying short fibers prior to electrospinning the subsequent layer.

48. The system of claim 6, wherein the electrospinning process includes electrospraying short fibers prior to electrospinning the subsequent layer.

49. The system of claim 5, wherein the electrospinning process includes electrospinning wet fibers by decreasing the screen distance to generate a “tacky surface” prior to electrospinning the subsequent layer.

50. The system of claim 6, wherein the electrospinning process includes electrospinning wet fibers by decreasing the screen distance to generate a “tacky surface” prior to electrospinning the subsequent layer.

51. A photocatalytic nanofiber-impregnated graphene aerogel comprising a graphene aerogel and nanofibers impregnated therein.

52. A method of desalinating and purifying water using the system of claim 1.

53. The method of claim 8, wherein the rate of water evaporation is greater than 1.3 gal/ft² per day.

54. The method of claim 5, wherein greater than 90% of contaminants are removed.
